(19) United States
(12) Patent Application Publication
(10) Pub. No.: US 2019/0232448 A1
(43) Pub. Date: Aug. 1, 2019

(54) FEEDING DEVICE FOR A TOOL MAGAZINE OF A MACHINE TOOL AND METHOD FOR CHANGING A TOOL ON A TOOL MAGAZINE

(71) Applicant: DECKEL MAHO PFRONTEN GMBH, Pfronten (DE)

(72) Inventors: Matthias MAYR, Füssen (DE); Axel KIENBERGER, Pfronten (DE)

(73) Assignee: DECKEL MAHO PFRONTEN GMBH, Pfronten (DE)

(21) Appl. No.: 16/262,285

(22) Filed: Jan. 30, 2019

(30) Foreign Application Priority Data
Jan. 30, 2018 (DE) 10 2018 201 426.4

(51) Int. Cl. B23Q 3/157

(52) U.S. Cl. CPC B23Q 3/15713

(57) ABSTRACT

A feeding device for a rotatable wheel magazine of a machine tool is proposed. The feeding device includes a manipulator for changing and inserting tools on the wheel magazine, wherein the manipulator is movably arranged along the first direction of movement and has at least one movable tool holder. A tool input unit is provided with tool input positions for tools to be introduced and/or replaced in the wheel magazine. The manipulator for changing and inserting tools on the wheel magazine is moved along the first direction of movement, making refilling of the wheel magazine easy and efficient.

The present invention relates to a device for changing and inserting tools on a tool magazine of a machine tool and to a method for changing and inserting tools on a tool magazine of the machine tool.

### BACKGROUND

Systems for changing and inserting or holding available tools on a machine tool and tool magazines for storing tools for a machine tool are described in different embodiments by the prior art. Tool changing systems are used, for example, in milling machining centers in order to reduce the non-productive times of the respective processing machine, for example the so-called chip-to-chip times.

With the aid of tool changing systems, tools can be changed from the tool magazine to a processing spindle of a machine tool and vice versa as required. If necessary, this is done in fully automated fashion and program-controlled. For this purpose, the tool magazines accommodate a plurality of tools for tool storage. The tools can be supplied to a machine tool by means of a manipulator for removing the tools from the tool magazine.

DE 10 2004 028 151 A1 discloses a storage arrangement for processing machines with bearing positions arranged one above the other, on the underside of which tool holders are fastened, which are arranged in a circle and from which tools can be removed by means of a movable gripper arm. The tools are removed here in a direction perpendicular to the held tool axis and radially inwards through the gripper arm.

Similar to chain magazines, circular or columnar tool magazines can store a large number of tools with faster access times to the tools compared to shelf magazines. In practice, however, shelf magazines often have to be used if only a narrow-width shelf magazine can be used next to the machine tool due to the limited space available.

With tool magazines according to the prior art, however, the problem arises that the tools have to be manually inserted when filling the wheel magazine. Heavy tools must also be manually inserted into the tool magazine. When exchanging or introducing the tools, the machine tool or the tool magazine cannot usually be put into operation as the manual filling process of the tool magazine must first be completed. Therefore, setup during machining is usually not possible. In addition, the users must wait for the machining operation to be completed before replacing or refilling tools into the tool magazine. In particular, replacement cannot be carried out while the machine tool is running.

One object of the invention is therefore to provide a device and a method for changing, inserting or holding available tools on a tool magazine (in particular a rotatable wheel magazine), in which the above-mentioned prior-art problems are solved.

In particular, a further object of the invention is to provide an improved device for changing and inserting tools on a tool magazine of a machine tool in order to allow setup during machining.

### SUMMARY

The above described objects are achieved according to the invention by a device and/or a method according to the independent claims. Preferred embodiments of the invention are described in the dependent claims.

In order to solve the problems, an input device according to the invention (tool input unit) is proposed. The input device for a tool magazine, e.g. a wheel magazine, of a machine tool includes a manipulator for changing and inserting tools on the tool magazine. The manipulator is movably arranged along a first direction of movement and has at least one tool holder. This tool holder is preferably a gripper for radially gripping tools from the tool magazine. A tool supplying unit with a movable tool trolley and at least one tool space for accommodating tools can additionally be provided. The manipulator for changing a tool on the tool magazine can be moved along the first direction of movement, in the direction of the tool supplying unit, to a transfer position. This advantageous device allows tools to be changed quickly and easily. The tools can be automatically removed from the tool supplying unit and introduced into the tool magazine via the manipulator. This allows an efficient and fast, preferably autonomous, refilling of the tool magazine. A manual lifting of the partly heavy tools is no longer necessary, as the introduction can be carried out automatically by the input device. This also makes it possible to refill and/or replace the tools of the wheel magazine during machining. Preferably, the input device can automatically recognize the type and position of the tools in the tool supplying unit. Furthermore, alternatively or additionally, the tools supplied can be introduced directly from the tool supplying unit into the spindle of the machine tool.

It is advantageous to have the tool space on a tool bar and, to remove a tool from the tool bar, a lifting device can be provided to lift the tool bar into the transfer position. Thus, a tool bar with several tool spaces can be provided, which has a compact design and can be filled manually. This tool bar can be supplied directly to the input device. The input device can autonomously remove the individual tools from the tool bar or fill the tool spaces with tools from the tool magazine to be exchanged. The lifting device also eliminates the need for manual lifting of the tools or tool bar so that replacement can be made even easier. This allows an efficient and fast refilling of the tool magazine.

In order to change a tool, the manipulator can advantageously remove at least one tool from the lifted tool bar in the transfer position. This allows an efficient and fast refilling of the tool magazine.

The lifting device can be advantageously equipped with a gripping member for picking up a tool bar and the gripping member can be moved along a lifting direction. The lifting device also eliminates the need for manual lifting of the tools or tool bar, making replacement even easier. This allows the tool magazine to be replenished quickly and efficiently.

It is advantageous that the gripping member of the lifting device can be suitable for lifting along the lifting direction in the transfer position and for turning the tool bar from an initial position into a transfer position, a simultaneous lifting and turning being preferably possible. The tool bar can preferably be rotated by 90° from the initial position to the transfer position. More preferably, the transfer place can be at the transfer position. The initial position of the tool bar can be substantially horizontal (i.e. the longitudinal axis of the tool bar is horizontal) and the transfer position can be substantially vertical (i.e. the longitudinal axis of the tool bar is vertical). This allows an efficient and fast refilling of the tool magazine.

It is advantageous that the tool supplying unit can include at least one tool bar and the tool space of the tool bar can be a manually loadable tool space for tools to be supplied. Preferably, the tool bar can be detachably fixed to the tool trolley.

It can be advantageous to fix the tool trolley at a setting position so that the tool bar provided on the tool trolley can be connected to the gripping member of the lifting device to lift the tool bar into the transfer position. The setting position can here be arranged directly next to the lifting device.

It is advantageous that the manipulator can be movable in translatory fashion along the first direction of movement and in translatory fashion along a second direction of movement. The first movement direction can be orthogonal to the second movement direction. This allows a particularly compact and efficient design of the input device, so that an efficient and fast refilling of the tool magazine is possible.

It is advantageous that the direction of movement of the manipulator can be essentially parallel to the axis of rotation of the tool magazine, exemplarily being a wheel magazine. Another advantage is that the first and second direction of movement of the manipulator can lie in one plane and the lifting direction can lie outside this plane. This allows a particularly compact and efficient design of the input device, so that an efficient and fast refilling of the tool magazine is possible.

The manipulator can be advantageously equipped with an extendable manipulator arm, which can be extended along the first direction of movement, and the manipulator can be moved in translatory fashion along a displacement axis in the second direction of movement. The manipulator can also be advantageously equipped with a rotatable manipulator arm.

It is advantageous that the tool bar can have six manually loadable tool spaces. In addition, the manipulator can be movable in such a way that tools from the tool bar can be introduced directly into a spindle of the machine tool.

An identification system can be advantageously used to identify the tools. The tool bar with the tools is preferably lifted and rotated for this purpose. This allows particularly efficient automated refilling and replacement, since the system can independently identify the provided tools and recognize the positions in which the respective tools are provided. It is preferable to read/write the tool data of the tools in the transfer position before removing the tool from the tool bar.

Advantageously, the identification system can automatically identify the tools included in the tool bar, and preferably the identification system can have a read/write head for reading and editing tool data from RFID media of the tools. The tools can preferably have stored tool data and the lifting device can lift and/or rotate the tool bar to a predefined position to read/write the tool data.

The manipulator can be advantageously equipped with at least one gripper for gripping at a tool interface of a tool. The tool holder of the manipulator can be rotated about an axis of rotation

It is advantageous that the tool trolley can accommodate at least two tool bars which are arranged parallel to one another. It is even more preferred to accommodate four tool bars, with two each being arranged parallel to each other.

An advantageous machine tool with a tool magazine, such as e.g. wheel magazine, can have an input device according to one of the previous features.

An advantageous method for changing tools of a tool magazine of a machine tool by means of an input device according to one of the preceding features can comprise the steps of: moving the tool bar from the tool supplying unit to a transfer position; supplying or removing a tool from the tool bar in the transfer position by the manipulator; moving the manipulator along the first direction of movement to introduce/replace the tool in the tool magazine.

The method can also advantageously include the steps of: lifting or lowering the tool bar with the at least one tool to be introduced along the lifting direction; removing a tool from the lifted and rotated tool bar by the manipulator; translating the removed tool with the manipulator along the first direction of movement; introducing the removed tool into the tool magazine.

The method can also advantageously include the step of: rotating the tool bar lifted along the lifting direction about an axis of rotation.

The method can also advantageously include the step of: Identifying the tool to be introduced via an identification system.

An advantageous development of the input device for a rotatable tool magazine, such as e.g. wheel magazine, of a machine tool can include a manipulator for removing tools from the tool magazine along a tool removal path. A tool supplying unit for supplying tools is preferably provided, wherein the tool removal path connects a tool position on the tool magazine and the tool input unit, and the manipulator for changing and/or inserting tools is controllable in such a way that a tool supplied on the tool input unit can be moved at least partially along the tool removal path by the manipulator and the tool supplied can be introduced into the tool magazine (or spindle) by the manipulator. At least one direction of movement along which the tool is movable by the manipulator extends axially along the rotatabletool magazine. In order to change tools on the tool magazine, the manipulator can be moved along the first and a second direction of movement which is along the tool removal path, and preferably the first direction of movement is orthogonal to the second direction of movement. The manipulator of the feeding device can also be moved in such a way that the spindle of the machine tool can be loaded directly.

The tool removal path can have at least several directly adjacent sections, and a first section can run along the lifting direction, a second section along a displacement direction, and a third section along a manipulator axis. In the first section, the tool bar is lifted, up to a transfer position. The adjacent second section is a linear displacement area along which the manipulator can be moved linearly after picking up the tool at the transfer position. The third section adjacent to the second section comprises a further linear movement range in which the manipulator arm is extended towards the wheel magazine with subsequent introduction movement into the tool magazine. It is advantageous that at least one rotary movement can be performed by the lifting device at the transition from the first section to the second section.

An advantageous feeding device (input device) for a rotatable tool magazine, such as e.g. wheel magazine, of a machine tool can include a manipulator for changing and inserting tools on the tool magazine. The manipulator is movably arranged along a first direction of movement and at least one movable tool holder is provided on the manipulator. A tool input unit with several uniformly arranged tool holding positions along a tool bar is provided for tools to be introduced and/or replaced in the tool magazine. The manipulator can be moved linearly along the first direction of movement to change and insert tools on the tool magazine and can engage in a lifted tool bar to remove or insert a tool. The tool holding positions each have an accommodating hole.

The feeding device can advantageously include a lifting device for lifting and feeding tools from the tool input unit to the manipulator at a transfer position located above the initial position of the tool input unit. The lifting device can include a gripping member for accommodating a tool bar and the gripping member can be movable along a lifting direction, the lifting direction being substantially vertical.

The tool input unit can include at least one tool bar with manually loadable tool holding positions for tools to be provided, the tool bar preferably having six manually loadable tool holding positions. The tool input unit can include a manually movable trolley (tool trolley).

The manipulator can be controlled to change and insert a tool into the tool magazine of the machine tool in such a way that a tool provided in the tool input unit is held by the manipulator and moved linearly along the first direction of movement.

The manipulator can have at least one, preferably two, grippers for engaging in a tool interface of a tool. The movable tool holder of the manipulator can be rotated about an axis of rotation. The manipulator can advantageously remove a tool from the tool magazine with a radial gripping movement.

The lifting device can be advantageously set up in such a way that the accommodated tool bar can be rotated by a rotation angle, the rotation angle being preferably greater than 45° and less than 180°.

A feeding device for a rotatable tool magazine, such as e.g. a wheel magazine of a machine tool comprises a manipulator and a tool input unit. The manipulator for changing and inserting tools on the tool magazine can be arranged to move along a first direction of movement and can have at least one movable tool holder. The tool input unit with tool holding positions for tools to be introduced and/or replaced in the tool magazine can be arranged at a distance from the rotatable tool magazine. The manipulator for changing and inserting tools on the tool magazine can be moved along the first direction of movement for introducing or replacing the tools.

### BRIEF DESCRIPTION OF THE DRAWINGS

FIG. 1: shows an overview of the feeding device for a rotatable wheel magazine of a machine tool;

FIG. 2: shows a tool input unit with two tool bars;

FIG. 3: shows the tool input unit, the shifting device and the manipulator in the area of the wheel magazine of the machine tool;

FIG. 4: shows a tool bar being lifted by the lifting device;

FIG. 5: shows the lifting device with a lifted tool bar which is rotated;

FIG. 6: shows the lifted and rotated tool bar on the lifting device;

FIG. 7: shows the lifted tool bar in an upper end position of the lifting device;

FIG. 8: shows the manipulator when removing a tool from the lifted tool bar;

FIG. 9: shows the manipulator with a picked-up tool when moving along the traverse axis of the manipulator;

FIG. 10: shows a tool bar with inserted tools;

FIG. 11: shows tool bars provided on the tool trolley.

### DETAILED DESCRIPTION

In the following, examples of the present invention are described in detail with reference to the attached drawings. The same or equal elements in the drawings can be marked with the same reference signs, but sometimes also with different reference signs. However, it should be noted that the present invention is in no way limited or restricted to the embodiments and design features described below, but also includes modifications of the embodiments, in particular those covered by modifications of the features of the examples described within the scope of protection of the independent claim.

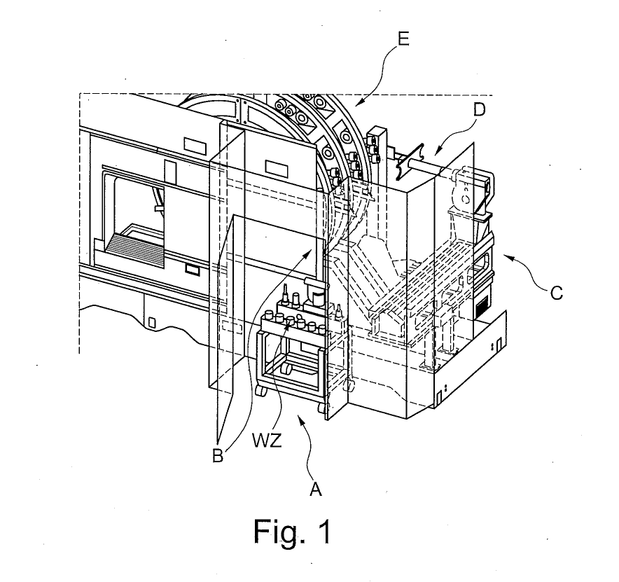

FIG. 1 shows a wheel magazine for a machine tool. The wheel magazine E has a plurality of tool holders which are loaded with tools. In addition, the wheel magazine has free spaces. The wheel magazine is mounted on various end points and is designed to be rotatable. The wheel magazine is rotated, for example, via a chain drive.

The tools arranged in the wheel magazine are attached at a longitudinal end to the outer circumference of the wheel magazine, so that the tools protrude radially outwards from the outer circumference of the wheel magazine in radiant fashion. Preferably, tools are arranged in tool holders, a self-retaining hollow shank taper with face contact (HSK) being used as interface (not shown in the drawings). Alternatively, a steel taper or Morse taper can also be used. The tools are held at an end point along the circumference of the wheel magazine. Tool holders are provided along the circumference of the wheel magazine and can form a detachable connection with the tools. The tools are preferably locked in the holders due to the centrifugal or gravitational force. The illustrated wheel magazine E comprises a plurality of wheel magazines arranged parallel to one another, which are mounted in such a way that they can rotate about an axis of rotation. The tool magazine can optionally be equipped with one or more wheel magazines E. Each wheel magazine can have its own drive, which causes the wheel magazine to rotate about the common axis of rotation. Each wheel magazine can therefore be driven independently of the other wheel magazines in order to bring the respective wheel magazine into a desired rotary position, so that the required tool can be removed or exchanged by the manipulator D.

Such a wheel magazine is known e.g. from DE 10 2011 082 050 A1, the subject matter of which is hereby deemed to be included. The tool magazine with the wheel magazines E, shown in FIG. 1, has various tools available, which can be removed from the respective wheel magazine E by means of the manipulator D in order to be introduced into the spindle of the machine tool by means of the manipulator D. If it is now necessary to exchange tools in the tool magazine, or to partially or completely reload the tool magazine, the tool magazine was stopped for this purpose, so that a manual exchange of the individual tools became possible. According to the present invention, it is now possible to simplify the replacement or loading of the tool magazine and to improve the efficiency of the entire system, including the machining times of the machine tool. In particular, it is possible by means of the proposed feeding device for tools to be exchanged, to load or exchange tools of the tool magazine even during machining, i.e. while the machine tool is in operation. In particular, the manipulator D is provided for this purpose on a shifting device C, which is preferably parallel to the axis of rotation of the wheel magazine E. This shifting device C, as shown in FIG. 1, allows the manipulator D to move along a shifting axis up to an area where the lifting device B is located with the tool input unit A.

The tool input unit A (also referred to as the tool supplying unit) can be, for example, a tool trolley on which the tools WZ to be exchanged or to be replaced are inserted via tool bars. In addition, the tool input unit can form a lockable space in which the tool trolley can be fixed so that the lifting device can be securely and easily docked to the tool bar. The tool WZ, which is provided in the respective bars, can be guided via the lifting device B to a transfer area, in which the displaced manipulator D can pick up the respective tool WZ in order to feed it to the wheel magazine E of the tool magazine at the desired position. In this way, it is also possible to transport tools to be exchanged from the wheel magazine E of the tool magazine via the manipulator D into the transfer area in order to add this tool to the tool bar again. The tool bar can again be added to the tool input unit A via the lifting device B. This allows an automated, simple and fast exchange and replacement of different tools directly from the tool magazine. A manual replacement of the individual tools from the wheel magazine is therefore superfluous. In particular, it is easily possible to load the different tool positions of the tool input unit A with new and, for example, maintained tools and to move this tool input unit A to the intended input position, so that an automatic exchange and introduction of the different tools is made possible in a simple way by the feeding device. This configuration allows setup to be carried out during machining. The tool bars with the tools WZ are preferably used for the simultaneous supply and removal of up to six tools. In addition, particularly heavy tools no longer have to be supplied manually to the respective wheel magazine E, but it is sufficient if the respective tools are supplied to the tool input unit A on the tool bar via the tool trolley.

It is possible in a particularly advantageous way to configure the feeding device such that, depending on the machining time and the machining steps to be carried out by the machine tool, it automatically decides when different tools are to be introduced into the tool magazine, so that a particularly time-efficient input of tools into the tool magazine is made possible. In addition, the user of the machine tool does not have to wait for the machine when changing tools WZ for the wheel magazine E, as he can immediately feed the new tools to the machine via the tool input unit A, so that the machine can introduce or replace the new tools independently, if necessary.

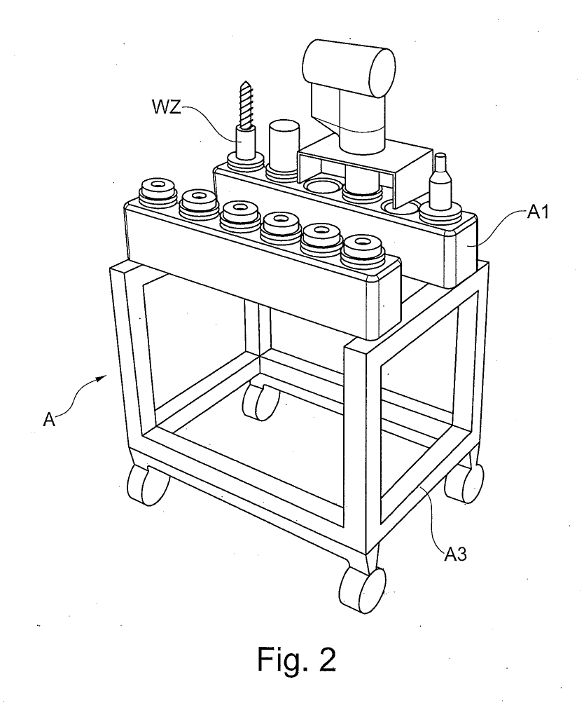

FIG. 2 is a detailed view of the tool input unit A. It consists e.g. of a tool trolley A3, which is arranged in such a way that it can be easily moved via wheels. This allows the user to transport even heavy tools to the desired place without having to lift all the tools. The tool trolley A3 includes fasteners which enable a detachable connection to the various tool bars A1. These tool bars A1 have holding spaces for tools, wherein six tool spaces per tool bar A1 are preferably provided. The individual tools WZ are preferably inserted into the individual holding spaces with the individual tool interfaces, so that these tools WZ can be removed from the individual tool bar A1 via the manipulator in order to be fed directly into the spindle of the machine tool or directly into the tool magazine.

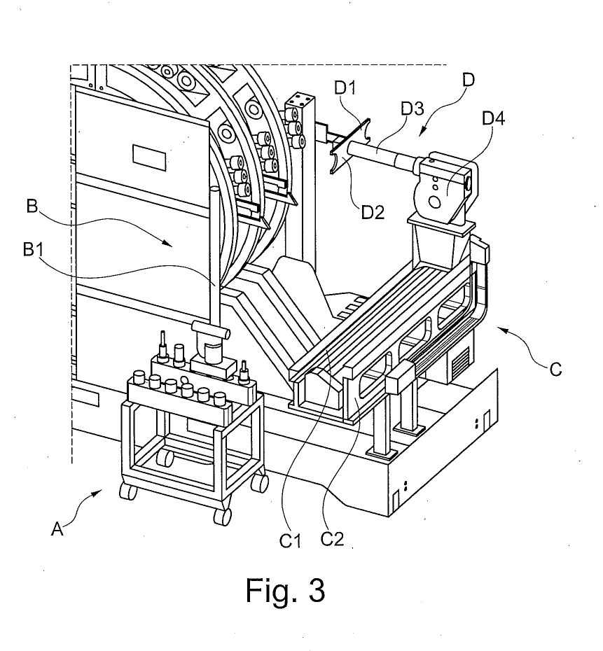

As shown in FIG. 2, the tool trolley A3 has fasteners that allow two tool bars to be inserted. The tools WZ are measured in the setting room and the data is stored on a tool identification chip. If the tool trolley A3 is now positioned at the intended position on the machine tool, as shown in FIG. 3, it is possible for the machine tool or the feeding device to automatically record the data of the individual tools as well as the position of the individual tools via these tool identification chips, so that autonomous removal of the individual tools can be made possible.

As shown in FIG. 3, the tool trolley A3 is positioned at a feeding position to allow engagement with the lifting device B. The lifting device B has a lifting direction B1, along which the individual tool bars A1 can be lifted. It is preferable to fix the tool trolley at the intended position in order to facilitate removal by the lifting device B.

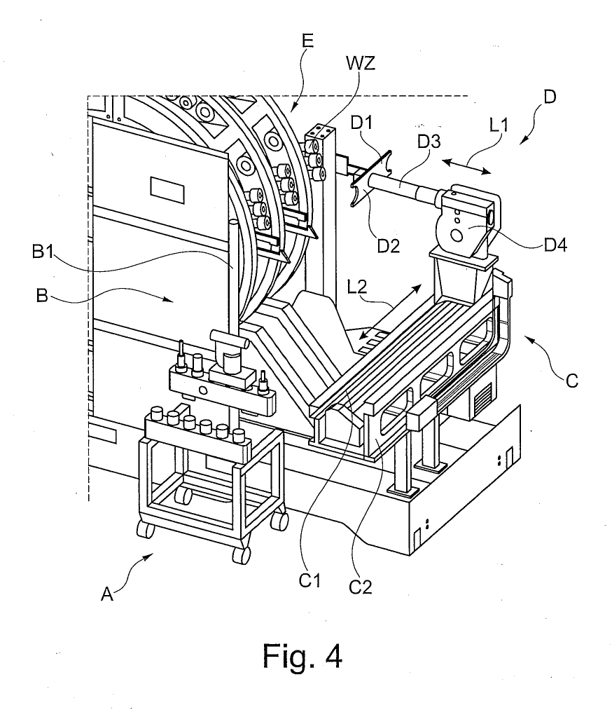

FIG. 4 shows the tool bar A1 in a lifted state. The tool bar A2 is still positioned in the tool trolley A3 of the tool input unit A. The tool trolley A3 is fixed directly in the holding area. The tool bar A1 is lifted by the lifting device along the lifting axis B1 in order to allow contact with the manipulator D or transfer of the tool to the manipulator D. The manipulator D has a manipulator arm D3, at the first end of which a first gripper D1 and a second gripper D2 are provided. At the opposite second end of the manipulator arm D3, the manipulator holder D4 is provided, which can determine a further axis of movement of the manipulator D. The manipulator D is designed as a swivel-blade exchanger with double gripper, with a first gripper D1 and a second gripper D2, for removing the tools in the embodiment shown. The double gripper allows the simultaneous pick-up of the tool last used and the tool subsequently required, so that tool exchange is possible with only one horizontal movement of the manipulator between spindle and tool magazine.

The manipulator D is arranged at the outer circumference of the wheel magazine E, the manipulator being movable along a first linear axis L1, so that the manipulator arm D3 is designed to be retractable and extendable. In other words, the manipulator D is designed in such a way that the position of the first gripper D1 and the second gripper D2 relative to the manipulator holder D4 can be extended or shortened. This makes it possible to extend or retract the manipulator arm D3 along the linear axis L1. In addition, the first and second grippers D1, D2 can be rotated. In particular, the grippers can be rotated about an axis of rotation which extends along the manipulator arm D3. This allows the first gripper D1 and the second gripper D2 to be rotated or swiveled. In addition, the manipulator D is movable along the second linear axis L2, so that a displacement of the manipulator D along the displacement axis C1 is possible. The shifting device C, which includes the main body C2, is provided for this purpose. The main body C2 preferably has rails and a chain drive, so that the manipulator holder D4 can be moved linearly along the second linear axis L2 with the manipulator D. In a further embodiment, the manipulator D can preferably have a further movement axis, which allows rotation around the manipulator holder D4.

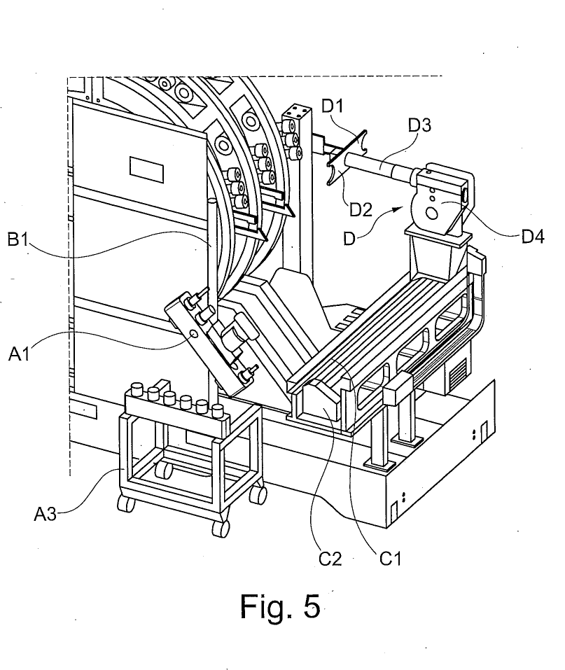

FIG. 5 shows the feeding device for the rotating wheel magazine E, where the tool bar A1 is rotated from the horizontal initial position to a vertical target position. The tool bar A1 is rotated to the vertical position so that the manipulator D with the gripper arms D1 and D2 can remove one or two tools. The tool bar A1 is lifted by the lifting device B along the lifting direction B1 and preferably rotated by 90°. After the rotation, the tools are oriented so that they can be removed directly by the grippers of the manipulator D. The lifting device B is preferably designed in such a way that the lifting of the tool bar A1 is simultaneously accompanied by the rotation of the tool bar from the horizontal to the vertical. Thus, two parallel motion sequences preferably take place.

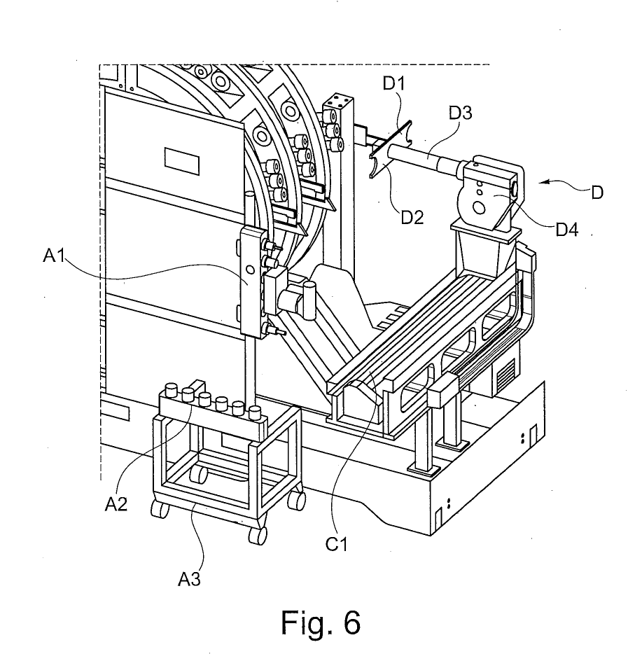

FIG. 6 shows the upper position of the lifting device B with the tool bar A1 in the vertical position. In the vertical position, the tools WZ of the tool bar A1 can be removed directly by the grippers D1, D2 of the manipulator D.

In order to remove the tool WZ from the tool bar A1, the manipulator D is moved along the displacement axis C1. For this purpose, the shifting device C is activated, which allows the linear movement of the manipulator D parallel to the axis of rotation of the wheel magazines E.

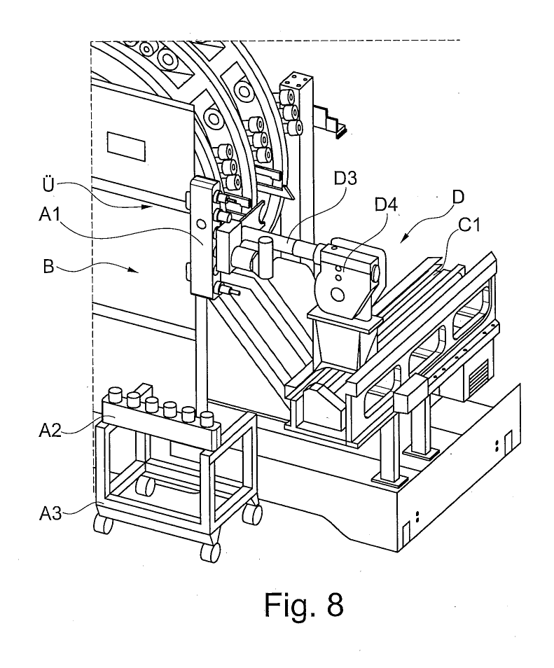

FIG. 8 shows the removal of a tool WZ from the tool bar A1, a gripper of the manipulator D engaging at the tool interface to unlock and remove the tool from the tool bar A1. The position of the manipulator and the tool bar A1 is the so-called transfer position U. For a tool transfer, both the manipulator D and the tool bar A1 (using the lifting device B, which rotates and lifts the tool bar) must be moved to the transfer position U.

The feeding device is preferably set up in such a way that automatic recognition of the individual tools, which are arranged in the tool bar A1, is made possible. In particular, tools which are provided in different plug-in locations of the tool bar A1 are automatically recognized. For example, the identification of the accommodated tools of the tool bar A1, A2 can be made possible via the provided tool identification chip of the individual tools or via an identification chip of the tool bar. For example, the lifting device B can be designed for this purpose in such a way that tool data can be identified and transmitted without contact or by touching the tool bar and/or the tools. The tool bar can be moved along the lifting direction B1 by means of the lifting device B, at the same time allowing the tool data to be read and written. The feeding device thus allows automatic tool identification. Depending on the tool to be removed or on the desired position in the tool bar, it can be moved vertically upwards or downwards along the lifting direction B1 in order to set a desired removal position. If, for example, a tool is required which is located in the lowest holding space of the tool bar A1, in the vertical alignment of the tool bar A1, as shown in FIG. 8, the tool bar A1 can be moved further vertically upwards along the lifting direction B1, so that the manipulator D can contact the tool interface of the tool to be removed directly with the respective gripper by linear movement. If, on the other hand, a tool is required at the uppermost tool position of the vertical tool bar A1 in FIG. 8, the tool bar A1 can be moved vertically downwards until the tool to be removed lies on a (in particular horizontal) plane with the gripper of the manipulator D.

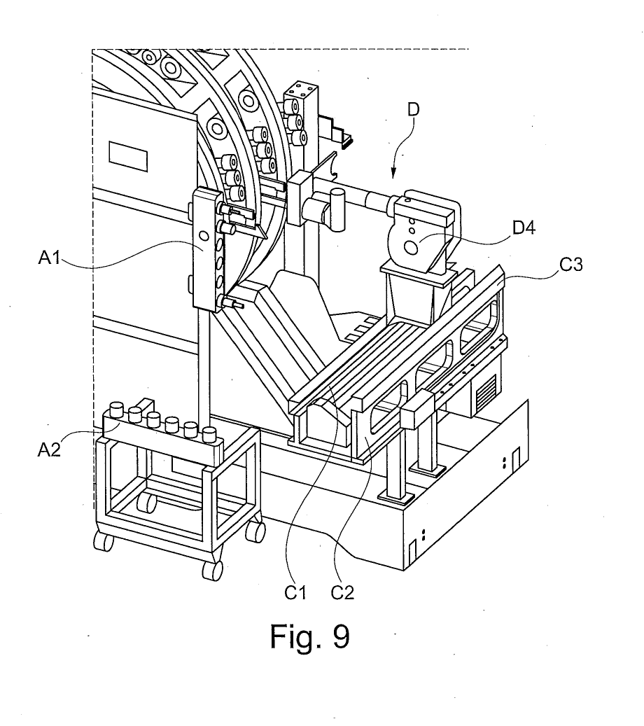

FIG. 9 shows the manipulator D, which has picked up a tool which was removed from the tool bar A1. The manipulator D is moved along the displacement axis C1 on the main body C2. The removed tool WZ can be introduced by the manipulator D directly into the wheel magazine E or can be directly introduced into the spindle of the machine tool. After removing all tools from the tool bar A1, it is placed back in the tool trolley.

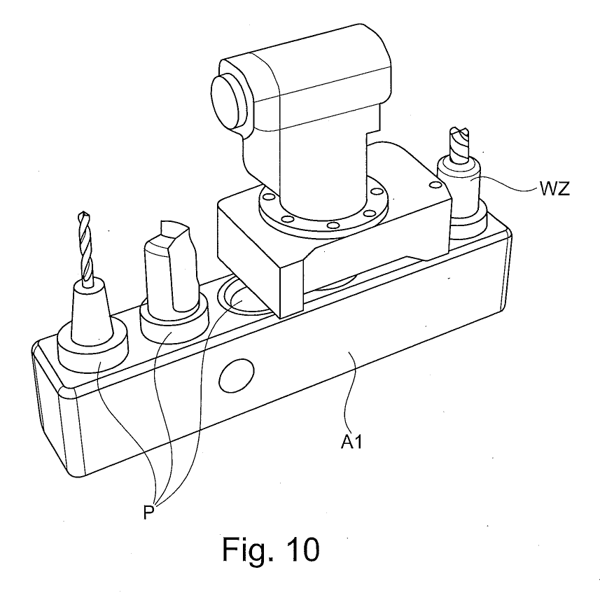

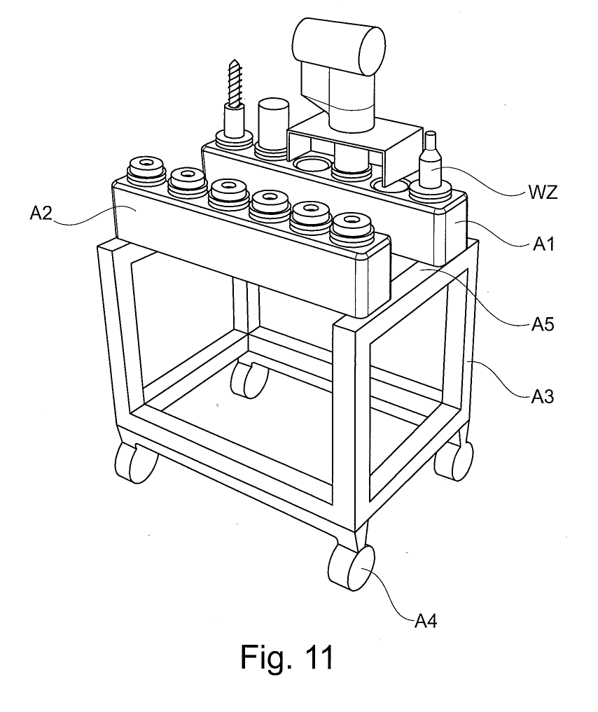

The tool bars can be arranged in various ways on the tool trolley A3. FIGS. 10 and 11 show a tool bar A1 and the tool trolley A3 with tool bars A1, A2 provided thereon. The tool bar A1 has different tools WZ, which are provided in the accommodating holes of the tool spaces P. The tools WZ here also include the tool interfaces, i.e. a clamping device for clamping the tool in the spindle. FIG. 11 shows a parallel arrangement of tool bars A1 and A2. It is more preferred to provide two parallel bars and two bars orthogonal thereto on the tool trolley A3. The tool trolley A3 also has wheels A4, which allow easy manual movement of the tool trolley A3 together with the tool bars A1 and A2 and the tools WZ.

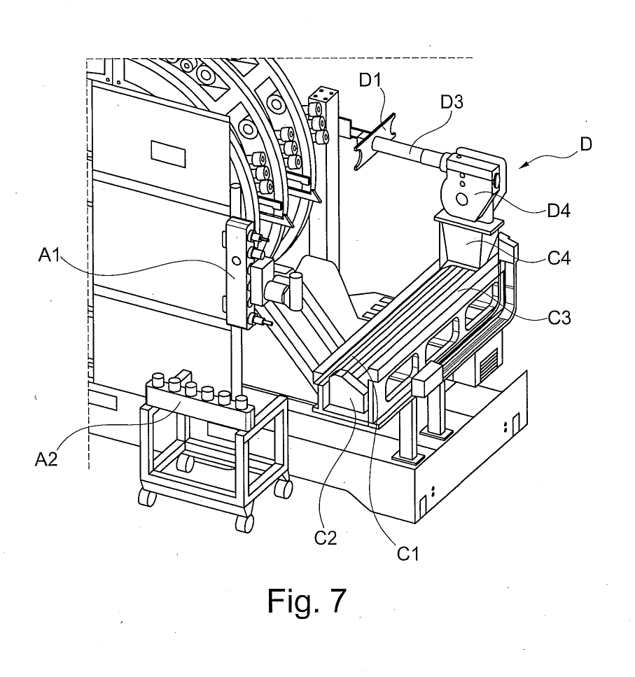

A method for feeding tools into a rotatable tool magazine or wheel magazine of a machine tool can therefore include the steps shown in FIGS. 3 to 9. The method can therefore include the lifting of the tool bar A1 with the lifting device B along the lifting direction B1. The tool bar can be rotated about an axis of rotation by at least 90°. The tool WZ can be removed from the lifted and rotated tool bar by the manipulator D via the gripper. In this position, it is also possible to feed tools into the tool bar via the gripper using the manipulator D.

In summary, a feeding device for a rotatable tool magazine of a machine tool is proposed according to the present invention, with which the rotatable wheel magazine can be refilled in a simple and efficient way. Heavy tools no longer have to be inserted manually and at the same time up to six tools can be inserted and removed simultaneously. In addition, the feeding device according to the invention allows setup during machining. The arrangement of the feeding device also results in a space-saving and cost-effective input station for a wheel magazine of the tool magazine.

1. An input device for a tool magazine of a machine tool, wherein
the input device has a manipulator for changing and inserting tools on the tool magazine and the manipulator is arranged movably along a first direction of movement and has at least one tool holder;
the input device being wherein a tool supplying unit having at least one tool space for accommodating tools is provided, and
the manipulator for changing a tool on the tool magazine is movable along the first direction of movement, in the direction of the tool supplying unit, to a transfer position.

2. The input device according to claim 1, wherein the tool space is provided at a tool bar and a lifting device for lifting the tool bar into the transfer position is provided for removing a tool from the tool bar.

3. The input device according to claim 2, wherein for changing a tool the manipulator removes at least one tool from the lifted tool bar in the transfer position.

4. The input device according to claim 2, wherein the lifting device has an engagement member for receiving a tool bar and the engagement member is movable along a lifting direction.

5. The input device according to claim 4, wherein the engagement member of the lifting device is arranged for lifting along the lifting direction into the transfer position and rotating the tool bar from an initial position into a transfer position.

6. The input device according to claim 1, wherein the tool supplying unit comprises at least one tool bar and the tool space of the tool bar is a manually loadable tool space for tools to be provided.

7. The input device according to claim 4, wherein a movable tool trolley can be fixed at a setting position so that the tool bar provided on the tool trolley can be connected to the engagement member of the lifting device, for lifting the tool bar into the transfer position.

8. The input device according to claim 1, wherein the manipulator is movable in a translatory fashion along the first direction of movement and in a translatory fashion along a second direction of movement.

9. The input device according to claim 8, wherein at least one direction of movement of the manipulator extends substantially parallel to the axis of rotation of the tool magazine being a wheel magazine.

10. The input device according to claim 8, wherein the first and second directions of movement of the manipulator lie in one plane and the lifting direction lies outside this plane.

11. The input device according to claim 8, wherein the manipulator has an extendable manipulator arm, which can be extended along the first direction of movement and wherein the manipulator can be moved in a translatory fashion along the second direction of movement along a displacement axis.

12. The input device according to claim 1, wherein the manipulator has a rotatable manipulator arm.

13. The input device according to claim 1, wherein the tool bar comprises six manually loadable tool spaces.

14. The input device according to claim 1, wherein the manipulator can additionally be moved in such a way that tools of the tool bar can be introduced directly into a spindle of the machine tool.

15. The input device according to claim 1, wherein an identification system is provided for identifying the tools.

16. The input device according to claim 15, wherein the identification system automatically identifies the tools accommodated in the tool bar.

17. The input device according to claim 1, wherein the tools have stored tool data and the lifting device lifts and/or rotates the tool bar into a predefined position to read/write the tool data.

18. The input device according to claim 1, wherein the manipulator has at least one gripper for engagement at a tool interface of a tool, and the tool holder of the manipulator can be rotated about an axis of rotation.

19. The input device according to claim 2, wherein a movable tool trolley at least two tool bars which are arranged parallel to one another.

20. A machine tool with a wheel magazine and an input device according to claim 1.

21. A method for changing tools of a tool magazine of a machine tool by means of an input device according to claim 1, comprising the steps of:
moving the tool bar from the tool supplying unit into a transfer position;
supplying or removing a tool from the tool bar located in the transfer position by the manipulator;
moving the manipulator along the first direction of movement to introduce/replace the tool into the tool magazine.

22. The method according to claim 21 wherein at least one of the following steps is performed:
lifting or lowering the tool bar with the at least one tool to be introduced along the lifting direction;
removing a tool from the lifted and rotated tool bar by the manipulator;
translating the removed tool with the manipulator along the first direction of movement and the second direction of movement;
introducing the removed tool into the wheel magazine.

23. The method according to claim 21, additionally comprising the step of:
rotating the tool bar lifted along the lifting direction about an axis of rotation.

24. The method according to claim 21, additionally comprising the step of:
identifying the tool to be introduced via an identification system.

25. An input device for a rotatable tool magazine of a machine tool, comprising
a manipulator for removing tools from the tool magazine along a tool removal path;
a tool supplying unit for providing tools;
wherein the tool removal path connects a tool position on the tool magazine and the tool input unit, and
the manipulator for changing and/or inserting tools can be actuated in such a way that a tool provided on the tool input unit can be moved along the tool removal path by the manipulator and the tool provided can be introduced into the tool magazine by the manipulator.
